(19) United States
(12) Patent Application Publication
(10) Pub. No.: US 2024/0124659 A1
(43) Pub. Date: Apr. 18, 2024

(54) METHOD FOR PRODUCING RESIN COMPOSITE MATERIAL, AND RESIN COMPOSITE MATERIAL

(71) Applicant: Takashi OHNO, Niigata (JP)

(72) Inventor: Takashi OHNO, Niigata (JP)

(21) Appl. No.: 18/394,705

(22) Filed: Dec. 22, 2023

Related U.S. Application Data
(63) Continuation of application No. PCT/JP2021/026707, filed on Jul. 15, 2021.

(51) Int. Cl. C08J 3/22; C08J 5/18; C08K 3/26; C08L 23/06

(52) U.S. Cl. CPC C08J 3/226; C08J 5/18; C08K 3/26; C08L 23/06; C08J 2323/06; C08J 2401/02; C08K 2003/267; C08L 2203/16; C08L 2207/20; C08L 2308/00

(57) ABSTRACT

A first mixture is formed by mixing a water-absorbing filler with a hydrous filler containing water in advance and adsorbing the water on the water-absorbing filler, then a second mixture is formed by mixing the first mixture with synthetic resin, then a melted and kneaded product is formed by feeding the second mixture into a closed container and heat-kneading the second mixture at a temperature at which the synthetic resin melts, and then the water contained in the melted and kneaded product is discharged to the outside by opening the closed container.

### CROSS-REFERENCE TO RELATED APPLICATIONS

This application is a Continuation Application of No. PCT/JP2021/026707, filed on Jul. 15, 2021, the entire contents of which are incorporated herein by reference.

### TECHNICAL FIELD

The present invention relates to a technique for producing a resin composite material that contributes to realization of sustainable development goals (SDGs).

### BACKGROUND

Development is underway on resin composite materials that reduce amount of synthetic resin to be produced from fossil resources by dispersing and combining a filler with synthetic resin and exhibit a new function.

It is known that a composite material with excellent mechanical strength can be obtained by mixing layered silicate with synthetic resin. As a method for producing such a resin composite material, in a disclosed technique (for example, Patent Document 1), raw material monomers for synthetic resin are polymerized in the presence of a predetermined amount of layered silicate, and synthetic resin and layered silicate are melt-kneaded.

The reason why such resin composite materials exhibit excellent mechanical strength is thought to be that a fine and dense dispersed phase of cleaved layered silicate is formed in the matrix of synthetic resin.

In another disclosed technique (for example, Patent Document 2), a biodegradable resin composite material is produced by effectively utilizing soy pulp to be discharged in large quantity during a production process of soybean curd.

Regarding fillers prone to re-agglomeration such as biomass, in a disclosed technique for forming a fine and uniform dispersed phase of a filler in the continuous phase of synthetic resin (for example, Patent Document 3), water (liquid medium) is added to the synthetic resin and the filler, then they are kneaded in a closed container at a temperature higher than the melting temperature of the synthetic resin, and then they are exposed to the atmosphere for vaporization and dehydration to produce a composite material.

Regarding fillers that are in the form of dry fine powder and easily scatter, in a disclosed technique (for example, Patent Document 4), synthetic resin, fine powder, and a liquid medium are mixed before heat input and kneading.

Regarding a clay mineral-based substance, in a disclosed technique (for example, Patent Document 5), a resin composite material with excellent physical properties is produced by gelating the clay mineral-based substance in a liquid medium and improving interfacial adhesion between the continuous phase of the synthetic resin and the dispersed phase of the filler.

### PRIOR ART DOCUMENT

### Patent Document

[Patent Document 1] JP 2004-269726 A
[Patent Document 2] JP 2010-209305 A
[Patent Document 3] Japanese Patent No. 4660528.
[Patent Document 4] Japanese Patent No. 5584807.
[Patent Document 5] Japanese Patent No. 6612948.

### SUMMARY

### Problem to be Solved by Invention

However, in the resin composite material of the layered silicate produced by the production method in Patent Document 1, it is difficult to uniformly form the fine dispersed phase of the layered silicate having been cleaved to a single layer level in the synthetic resin. Thus, there is a problem that toughness of the resin composite material decreases when the blending amount of the layered silicate exceeds 10% by weight.

In the biodegradable resin composite material produced by the method of Patent Document 2, there is a problem that its production efficiency is low due to the need to dry and pulverize the wet soy pulp immediately after the discharge and its dispersibility is also low due to re-agglomeration by drying. Furthermore, the lipid contained in soy pulp has an odor unique to soybeans, and there is another problem that its production efficiency is further reduced because of the need to eliminate this odor by a degreasing process with the use of a solvent.

In the respective techniques of Patent Documents 3 and 4, though addition of an excessive liquid medium (water) is required to ensure fineness and uniformity of the dispersed phase in the case of increasing the blending ratio of a filler with strong agglomerating properties, there is a problem that a large amount of vaporization heat is removed from the kneaded product at the time of discharging this liquid medium.

In the technique of Patent Documents 5, though the gelled clay mineral-based substance maintains its dispersibility without re-agglomeration, the gelled product contains a large amount of excessive water and this causes the problem of difficulty in increasing the blending ratio because the water remaining solid in the gelled product at room temperature vaporizes at the time of heating and melting.

In view of the above-described circumstances, an object of the present invention is to provide a highly-functional resin-composite-material production technique, which enables utilization of hydrous fillers such as high water-content waste previously considered as difficult to use for resin composite materials and thereby is reduced in consumption amount of synthetic resin and excellent in filler dispersibility and production efficiency.

### Means for Solving the Problem

A method for producing a resin composite material according to the present invention includes steps of: forming a first mixture by mixing a water-absorbing filler with a hydrous filler containing water in advance and adsorbing the water on the water-absorbing filler; forming a second mixture by mixing the first mixture with synthetic resin; forming a melted and kneaded product by feeding the second mixture into a closed container and heat-kneading the second mixture at a temperature at which the synthetic resin melts; and discharging the water contained in the melted and kneaded product to outside by opening the closed container.

### Effect of the Invention

The present invention provides a highly-functional resin-composite-material production technique, which enables utilization of hydrous fillers such as high water-content waste previously considered as difficult to use for resin composite materials and thereby is reduced in consumption amount of synthetic resin and excellent in filler dispersibility and production efficiency.

### BRIEF DESCRIPTION OF DRAWINGS

FIG. 1 shows a side view of a production system for a resin composite material according to the first embodiment of the present invention ((A) in FIG. 1), and a side view of an inflation molding machine that molds the resin composite material into a film ((B) in FIG. 1).

FIG. 2A and FIG. 2B are a Y-Z cross-sectional view and a Y-X cross-sectional view of a kneading apparatus that executes the method for producing a resin composite material according to the second embodiment of the present invention, respectively.

FIG. 3 is a flowchart of the method for producing a resin composite material according to the embodiment of the present invention.

FIG. 4 is a table illustrating a comparative example and an example in which the effects of the present embodiment are affirmed.

### DETAILED DESCRIPTION

### First Embodiment

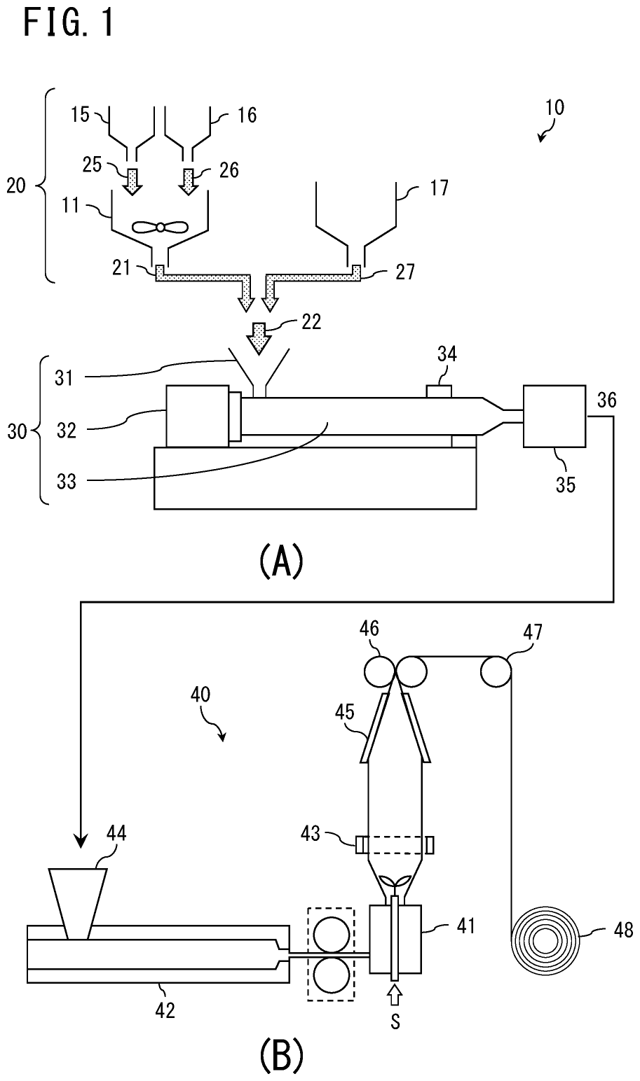

Hereinbelow, embodiments of the present invention will be described by referring to the accompanying drawings. (A) in FIG. 1 is a side view of a production system 10 that executes a method for producing a resin composite material according to the first embodiment of the present invention. This production system 10 is composed of a raw material supply apparatus 20 and a kneading apparatus 30. The kneading apparatus 30 includes a feeder 31, a drive unit 32, a cylinder 33, a vent unit 34, and a pelletizer 35. Inside the cylinder 33, a screw (not shown) to be rotated by the driving force of the drive unit 32 is provided.

The raw material supply apparatus 20 includes: a first container 15 that accommodates a hydrous filler 25 containing water (wet) in advance; a second container 16 that accommodates a water-absorbing filler 26; a first mixing tank 11 in which a first mixture 21 is formed by mixing the hydrous filler 25 with the water-absorbing filler 26 to adsorb the water on the water-absorbing filler 26; and a third container 17 that accommodates pelleted synthetic resin 27. Although not illustrated, a second mixing tank (not shown) in which the first mixture 21 and the synthetic resin 27 are mixed to form the second mixture 22 may be further provided. In some cases, this second mixture 22 is formed into a compressed product and then is fed into the cylinder 33.

Aspects of the hydrous filler 25 include, specifically, soy pulp to be discharged during a soybean-curd production process. This soy pulp is the residue after squeezing soy milk from soybeans, and contains approximately 75% to 80% water during the distribution stage. Data have been reported that dried soy pulp contains 26% crude protein, 13% crude fat, 33% soluble nitrogen-free substances, and 15% crude fibers. Most of the crude fibers are cellulosic substances. The soluble nitrogen-free substances are carbohydrate except the crude fibers, and contain a large amount of starch-based substances.

In the soy pulp, soluble inorganic nitrogen is contained as a hydrophilic substance, so cellulosic substances do not agglomerate and maintain a dispersed state, and protein with a three-dimensional structure maintains the three-dimensional structure by water and are finely dispersed in the continuous layer of synthetic resin. Hence, consumption amount of the synthetic resin to be compounded can be significantly reduced, and it can be formed into a thin sheet or film.

In addition to the above-described soy pulp, aspects of the hydrous filler 25 include: steam extraction residues such as a tea residue, a medicinal herb residue, and a coffee residue; distillation residues such as a residue of shochu and a residue of whiskey; brewing residues from sake, beer, and wine; juice residues from fruits and vegetables; other food residues; waste pulp generated at a paper factory; organic sludge generated in a chemical factory; organic sludge such as livestock excreta; sewage sludge; bentonite sludge generated in civil engineering work; high water-content construction sludge generated in construction work; gravel cleaning sludge; aluminum hydroxide sludge; metal surface treatment sludge; polishing sludge; filter aid waste; wastewater treatment sludge in a cement factory; water purification (water supply) sludge; compost; and algae-based biomass.

Starch-based substances include: cereals such as corn, wheat, and old rice; and tubers and roots such as a potato, a sweet potato, a cassava (raw material for tapioca), and a taro. Wheat bran and rice bran produced at the time of milling cereals are also preferably used. When these starch-based substances are placed at a common kneading temperature Tz (70 to 200° C.) in the presence of a predetermined amount of water or more, these starch-based substances cause a gelatinization phenomenon in which water molecules enter and the crystal structure collapses to cause a transition into an amorphous structure, and are finely dispersed in the matrix of the synthetic resin 27. For this reason, even if the starch-based substances are agglomerated starch particles with a low water content, these starch-based substances are gelatinized by the water contained inside the closed container and thus can be used as the hydrous filler 25.

Cellulosic substances include wood, rice straw, rice husk, waste paper (newspaper, magazines, other recycled pulp, or cardboard), and waste cotton products. These can be used in the form of chips, fibers, powder, or microfibrils. Chitin and chitosan-based substances include outer skins of a squid and crustaceans such as a crab and a shrimp.

Furthermore, the above-described hydrous filler 25 is supplemented with water and thereby is adjusted to exhibit the properties of a suspension in some cases. Specifically, for substances with strong agglomerating properties such as cellulosic substances, the hydrous filler 25 can be pulverized in a water solvent by using a homogenizer to produce a homogeneous suspension. In addition, inorganic materials that readily gelate only by adding water, such as bentonite and metal hydroxide, can also be used as the gelled hydrous filler.

Further, the hydrous filler 25 with gelled or suspension-like properties can also be used after being concentrated with a liquid medium except water. This allows the target substance to be finely dispersed in the matrix of the synthetic resin at a higher concentration without reducing the production efficiency. For this liquid medium, a liquid medium compatible with the filler is selected. In the case of layered clay mineral, ethylene glycol is preferably used. In the case of cellulosic nanofibers, polyols or polyethylene glycol with a molecular weight of 400 or less are preferably used.

When the hydrous filler 25 with the above-described properties is used, during the process of discharging excessive water by heating in the present embodiment, even substances that do not dissolve in water excluding starch-based substances can be kept dispersed by hydrogen-bonded water molecules without agglomeration and be finely dispersed in the matrix of the synthetic resin.

Furthermore, the hydrous filler 25 can be mixed with not only the synthetic resin but also a liquid medium that does not agglomerate the hydrous filler. Specifically, monomers, oligomers, fatty acids, polyols, glycols, emulsions containing polymer particles, and latex can be used. Since these materials can be used, efficient resource recycling can be achieved and the physical properties of the resin composite material can be readily adjusted.

Regarding the water-absorbing filler 26, it is satisfactory if the water-absorbing filler 26 is a dry substance on which excessive water contained in the hydrous filler 25 is adsorbed to enhance the production efficiency of the resin composite material. Substances contributing to improvement in physical properties of the resin composite material are preferably used for the water-absorbing filler 26. Specifically, substances containing layered silicate that swells with water are included, and clay mineral-based substances containing montmorillonite as the main component thereof, such as bentonite, are preferably used. When the layered silicate adsorbs water so as to swell and gelate, via single-layer exfoliation, the layered silicate is formed into a nanosheet. Among these, kaolinite, which has high viscosity-increasing properties due to water absorption, is highly effective in reducing the amount of synthetic resin to be used. Aside from them, thickeners and water absorbing agents (gelling agents) such as pectin, carrageenan, xanthan gum, galactomannans, gum arabic, methyl cellulose, hydroxypropyl methyl cellulose (HPMC), carboxyl methyl cellulose (CMC), gelatin, and water absorbing resin can also be used.

Furthermore, inorganic compounds with high solubility in water are also preferably used, including: dolomite hydroxide and other hydroxide; hydrate of metal oxide; chloride such as calcium chloride and magnesium chloride; and inorganic compounds such as sulfide including sodium thiosulfate. They are soluble in water and can be used in any form.

In addition, substances that do not dissolve in water can also be preferably used as the water-absorbing filler 26 if they are in a fine powder form, in a fibrous form, in a flocculent form, or in a porous form. Specifically, ore, metal, volcanic ash, and industrial waste such as fly ash and sander powder can be used if they are in a fine powder form. In the case of cellulosic substances, substances in which fibers are strongly agglomerated, such as waste paper (newspaper, magazines, other recycled pulp, or cardboard), are preferably used if they have been defibrated into fibers or cotton. As to the substances in a fibrous or floccular form, in addition to biomass products such as silk waste products and wool waste products, waste products of fibers and nonwoven fabrics derived from polymer compounds, which have a higher thermal fluidity than the synthetic resin as the matrix or is highly compatible with the synthetic resin, can also be used. Regarding porous substances that are not atomized during the kneading process, it is preferable to use them after pulverization.

The water-absorbing filler 26 to be applied in the embodiment is not limited to the above-described substances, and it is satisfactory if the water-absorbing filler 26 is a dry substance that can adsorb water. Various functions derived from the filler are exhibited by combining them. In addition, combining the water-absorbing filler 26 of dolomite hydroxide (a mixture of calcium hydroxide and magnesium hydroxide) gives the resin composite material deodorizing properties, antibacterial properties, and flame-retardant properties.

The synthetic resin 27 forms the matrix of the resin composite material. Any one of thermoplastic resin that melts by being heated and thermosetting resin that indurates by being heated can be adopted as the synthetic resins 27.

As the thermoplastic resin, the substances listed below in the form of pellets can be used without any particular restrictions on both conditions that they have the property of thermal fluidity by being heated and they can generally be extruded, as exemplified by: polyolefin-based resin such as low-density polyethylene (LDPE), high-density polyethylene (HDPE), and polypropylene (PP); polycarbonate resin (PC); polyethylene terephthalate resin (PET); acrylic/butylene/styrene (ABS); polyvinyl chloride (PVC); polystyrene (PS); polyamide (PA); polybutylene adipate-butylene terephthalate copolymer (PBAT) which is decomposed into water and carbon dioxide by action of microorganisms in the soil; and biodegradable plastic such as polylactic acid (PLA).

Furthermore, the above-described thermoplastic resin may be used as a mixture of two or more. Moreover, a recycled product of the above-described thermoplastic resin can also be used.

From among them, when biodegradable plastic such as polylactic acid (PLA) and polybutylene adipate-butylene terephthalate copolymer (PBAT) is adopted as the synthetic resin of the embodiment, a resin composite material suitable as a molding raw-material for container packaging materials and/or agricultural materials to be buried in the soil is provided. The biodegradation rate and ocean degradability of the resin composite material can be enhanced by adding the hydrous filler 25 such as protein-based substances and polysaccharide-based substances to the synthetic resin 27 of the biodegradable plastic. Although PBAT is known as biodegradable resin with high strength, inflation molding with an annular mold is difficult in the case of PBAT. However, combining these fillers enables efficient inflation molding. As to PLA, a thin film can be formed by adding latex to PLA, which greatly expands its range of use.

The feeder 31 feeds a second mixture 22, which is a mixture of the first mixture 21 and the synthetic resin 27, into the cylinder 33 that is a closed container. When the first mixture 21 containing the layered silicate swollen and gelated by adsorbing water is mixed with the pellet-shaped synthetic resin 27, due to the viscosity of the gelled layered silicate, the second mixture 22 in which the layered silicate is spread on the surface of the pellet-shaped synthetic resin 27 is formed.

Since the cylinder 33 is set at a temperature at which the synthetic resin 27 melts, the rotation of the screw heats and kneads the second mixture 22 into a melted and kneaded product. When the melted and kneaded product of the second mixture 22 is further heated and kneaded, the hydrous filler 25 (such as soy pulp) and the water-absorbing filler 26 (such as layered silicate) are uniformly dispersed in the matrix of the melted synthetic resin 27 under the state in which re-agglomeration is suppressed by the action of water under high temperature and high pressure conditions in the closed system.

The vent unit 34 opens the cylinder 33 that is a closed container and thereby discharges the water contained in the melted and kneaded product of the second mixture 22 to the outside. As a result, a melt of the resin composite material in which the fine hydrous filler 25 (such as soy pulp) is uniformly dispersed in the matrix of the synthetic resin 27 is formed. At this time, the nanoparticles (nanosheet) of the water-absorbing filler 26 (such as layered silicate) act as a bonding bridge between the molecular chains of the synthetic resin 27 and the hydrous filler 25 (such as soy pulp) so as to improve the interfacial adhesion between both.

The melt of the resin composite material having been dehydrated in the vent unit 34 is discharged from the most downstream portion of the cylinder 33. This dehydration process is desirably performed in such a manner that the water content at the heat flow temperature is 1% or less. The discharged melt of the resin composite material is branched into bundles in the pelletizer 35, then is cooled and solidified, and then is shredded and cut into pellets of the resin composite material 36. Although it is preferred that the water content is 0.3% or less for thin-walled inflation molding, molding defects due to water foaming and the like can be avoided by using such pellets, water content of which is controlled below a certain level at the setting temperature.

After being distributed on the market, the pellet-shaped resin composite material 36 becomes a raw material for producing general polymer processed molded products by: (i) being heated and re-melted in an injection molding machine (extruder 42) and then being injected into a mold to be formed into a bulk product; (ii) being stretched by, for example, an inflation method, a calendar processing method, a T-die method, or a blowing method into a sheet or film-shaped molded product of 0.2 mm or less; or (iii) being foamed into a foam molded product.

(B) in FIG. 1 is a side view of an inflation molding machine 40 that molds the resin composite material into a film. The inflation molding machine 40 melts the pellet-shaped resin composite material 36 and molds it into a cylindrical thin film. In the inflation molding method as shown in (B) in FIG. 1, the pellet-shaped resin composite material 36 is fed into a hopper 44 of the extruder 42. This extruder 42 heats and melts the resin composite material 36, and then extrudes the melt into a cylindrical shape from an annular mold (die) 41 attached to the end.

Furthermore, air S is blown into the inside of this cylindrical melt to stretch the melt, which is then cooled by a cooling ring 43 and formed into a thin cylindrical film. This formed cylindrical film is guided by a stabilizing plate 45, is passed through a pinch roll 46 to remove the internal air, and then is passed through a guide roll 47 and wound up by a winding apparatus 48.

The resin composite material according to the production method of the present embodiment can be formed into a film with excellent mechanical properties such as tensile strength and impact resistance by using the hydrous filler 25, the water-absorbing filler 26, and the synthetic resin 27 as the starting raw materials. This is thought to be because the dispersed phase of the hydrous filler 25 mediated by the nanosized water-absorbing filler 26 is finely and uniformly formed with further improved interfacial adhesion in the melted matrix of the synthetic resin 27.

For this reason, the hydrous filler 25 and the water-absorbing filler 26 do not agglomerate and there are no defective regions, and thus, the film can be stretched to a uniform thickness. Hence, after cooling, the obtained film molded product has a uniform film thickness, a beautiful appearance, and has excellent mechanical properties (such as tear strength) without defects such as cracks and pinholes even in the case of increasing the degree of stretching.

### Second Embodiment

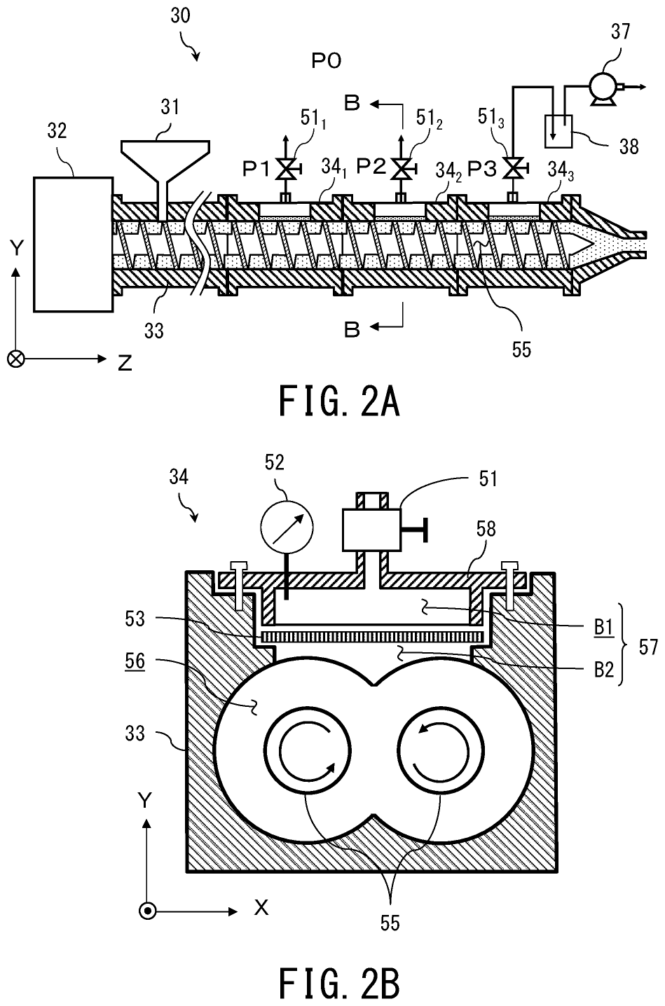

FIG. 2A is a Y-Z cross-sectional view of the kneading apparatus 30 that executes the method for producing a resin composite material according to the second embodiment of the present invention. FIG. 2B is a Y-X cross-sectional view of the kneading apparatus 30, i.e., a cross-sectional view taken along the line B-B in FIG. 2A. In the kneading apparatus 30 in FIG. 2, the components having the same configuration or function as those in FIG. 1 are indicated by the same reference signs, and duplicate description is omitted.

The kneading apparatus 30 shown in FIG. 2 has vent units 34 (34₁, 34₂, 34₃) installed in three stages. The water contained in the melted and kneaded product is sequentially discharged from the vent units 34 (34₁, 34₂, 34₃) in which the respective restriction amounts of release valves 51 (51₁, 51₂, 51₃) are adjusted. The most downstream vent unit 34₃ is provided with a decompression pump 37 and a trap 38.

In FIG. 2, the internal pressures (values of pressure gauges 52) of the vent units 34 (34₁, 34₂, 34₃) are adjusted by adjusting the opening degree of the release valves 51 (51₁, 51₂, 51₃) respectively provided for the vent units 34₁, 34₂, 34₃ so as to slope from the upstream side in the order of P1>P2=P0>P3. In this case, the release valves 51 for setting the internal pressures P2 and P3 are fully opened. Dehydration at a pressure higher than the atmospheric pressure P0, such as this internal pressure P1, is effective in preventing radical vaporization of water and suppressing agglomeration of the filler when the melted and kneaded product contains a large amount of water.

As shown in FIG. 2B, each vent unit 34 includes: a vent hole 57 penetrating a barrel hole 56, in which a screw 55 is disposed, from the orthogonal direction; a presser portion 58 provided at the opening of the vent hole 57; and a filter portion 53 that partitions the space of the vent hole 57 into a first space B1 continuous with the atmosphere side and a second space B2 continuous with the barrel hole 56.

Since the vent units 34 are configured in this manner, the closed system is switched to an open system when the melted and kneaded product moving through the barrel hole 56 reaches the opening position of the vent hole 57. As a result, the pressure to be applied to the melted and kneaded product decreases, which causes the contained water to vaporize and expand all at once. This vaporized and expanded water also involves the liquid component and the solid component of other melted and kneaded products so as to try to flow out through the vent hole 57.

However, these liquid component and solid component cannot pass through the filter portion 53 and are further pushed back by the rigidity of the filter portion 53 so as to be pushed out toward the downstream of the cylinder 33. The vaporized and expanded water passes through the filter portion 53 and is discharged to the outside from the open valves 51. Consequently, the water in the melted and kneaded product is removed without causing vent-up.

Although the kneading apparatus 30 is illustrated as a continuous-type kneading apparatus with two-shaft screws 55 in the above description, the number of the rotating screws of the kneading apparatus 30 may be one, three, or more and a batch-type kneading apparatus such as a kneader and a Banbury mixer may also be adopted.

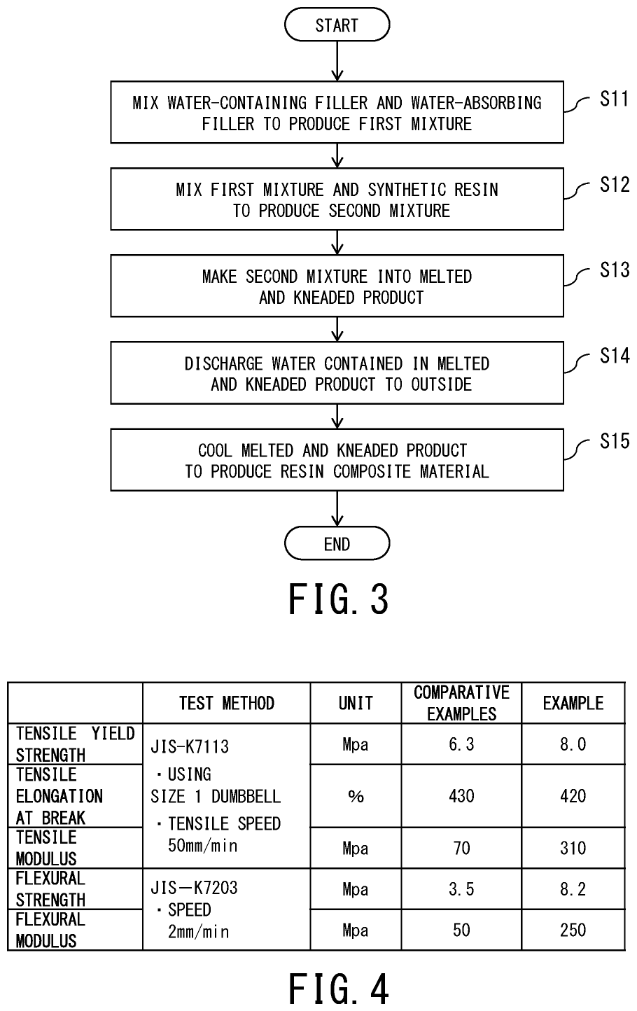

FIG. 3 is a flowchart of the method for producing a resin composite material according to the embodiment of the present invention (refer to FIG. 1, as required). Note that embodiments of this production method is not limited to the embodiment of the production system 10 described above.

In the step S1, the hydrous filler 25 containing water in advance and the water-absorbing filler 26 are mixed, and thereby the water is adsorbed on the water-absorbing filler 26 to form the first mixture 21.

In the next step S12, the first mixture 21 and the synthetic resin 27 are mixed to form the second mixture 22.

In the next step S13, the second mixture 22 is fed into the closed container 33 and then heated and kneaded at a temperature at which the synthetic resin 27 melts, and thereby a melted and kneaded product is formed.

In the next step S14, the water contained in the melted and kneaded product is discharged to the outside by opening the closed container 33.

In the final step S15, the melted and kneaded product from which the water has been discharge outside is cooled, shredded, and made into pellets (resin composite materials 36).

After being distributed on the market, the pellet-shaped resin composite materials 36 are re-melted in an injection molding machine and formed into various molded products. Specifically, mulch films, seedling pots, and stretch films to be used for agricultural materials and packaging materials are included. Additionally, flat yarns to be used for civil engineering materials, agricultural materials, and packaging/packing materials are included. Further, a sheet which has a hollow structure extruded by a special die and serves as a substitute for cardboard (commonly known as pladan) is included.

Furthermore, hollow molded products made by blow molding include bobbers, floats, buoys, and the like. A product which is formed of a stringy body with a three-dimensional hollow structure extruded by a strand die and is used as a substitute for urethane foam, such as bedding (pillows, mats, and the like) and core materials for chairs and sofas, is included.

Moreover, polypropylene or/and polyethylene is used as the synthetic resin 27, and a substance containing at least one of a medicinal herb residue, a tea dreg, and a leaf of Ginkgo biloba is used as the hydrous filler 25. Films of 0.1 mm or less extruded by the inflation method can be used as antibacterial films.

Further, polylactic acid (PLA) or polypropylene and/or polyethylene are used as the synthetic resin 27, and tomato stems are used as the hydrous filler 25. The molded product of the resin composite material produced in this manner adsorbs ethylene gas and is effective in preserving the freshness of vegetables and fruits.

Additionally or alternatively, clay mineral-based substances are used. Molded products made by injection molding or contour extrusion can be used as a substitute for flame-retardant concrete products.

In addition, aluminum sludge is used as the hydrous filler 25, and hydroxide or a clay mineral-based substance is used as the water-absorbing filler 26. Molded products produced in this manner are used as flame-retardant building materials.

Further, a purified water residue is used as the hydrous filler 25, and a clay mineral-based substance is used as the water-absorbing filler 26. A film of 0.1 mm or less can be formed by the inflation method, and a bag with a deodorizing effect is provided.

Moreover, a sheet or film with gas barrier properties is formed by: adding fatty acids or polyhydric alcohol such as ethylene glycol, glycerin, and waste cooking oil in addition to the composition of the hydrous filler 25, the water-absorbing filler 26, and the synthetic resin 27; and heating and melting them.

Furthermore, dolomite hydroxide emulsified by water is used as the hydrous filler 25. Additionally or alternatively, dried dolomite hydroxide is used as the water-absorbing filler 26. The molded product of the resin composite material produced in this manner can be used as a product with antibacterial properties.

### Example

Next, on the basis of the table of FIG. 4, a description will be given of a comparative example and an example in which the effects of the present embodiment are affirmed. In the comparative example, polyethylene was re-pelletized. In the example, a resin composite material was produced by the method of the embodiment described in FIG. 3. The resin composite material of the example is a compound of the synthetic resin 27 (polyethylene of the comparative example), the hydrous filler 25 (made into a gel or suspension by adding water to crushed waste paper which is a hydrophilic substance), and the water-absorbing filler 26 (dolomite hydroxide) in a weight ratio of 50:40:10.

Even if the blending ratio of the synthetic resin is 50%, the elongation is almost unchanged, and the strength is significantly improved due to the fibers of the waste paper. In addition, antibacterial properties and deodorizing properties are exerted due to the dolomite hydroxide.

According to the above-described technique of producing a resin composite material, the resin composite material with excellent dispersibility of the fillers 25 and 26 in the matrix of the synthetic resin 27 is provided. In addition, the odor emitted by the hydrous filler 25 is absorbed by the water-absorbing filler 26, so there is no need for special deodorizing treatment, and consequently, the production efficiency of the resin composite material is improved.

### REFERENCE SIGNS LIST

10 production system
11 first mixing tank
15 first container
16 second container
17 third container
20 raw material supply apparatus
21 first mixture
22 second mixture
25 hydrous filler (filler)
26 water-absorbing filler (filler)
27 synthetic resin
30 kneading apparatus
31 feeder
32 drive unit
33 closed container
33 cylinder
34 vent unit
35 pelletizer
36 resin composite material
37 decompression pump
38 trap
40 inflation molding machine
42 extruder
43 cooling ring
44 hopper
45 stabilizing plate
46 pinch roll
47 guide roll
48 winding apparatus
51 release valve
52 pressure gauge
53 filter portion
55 screw
56 barrel hole
57 vent hole
58 presser portion

1. A method for producing a resin composite material comprising steps of:
forming a first mixture by mixing a water-absorbing filler with a hydrous filler containing water in advance and adsorbing the water on the water-absorbing filler;
forming a second mixture by mixing the first mixture with synthetic resin;
forming a melted and kneaded product by feeding the second mixture into a closed container and heat-kneading the second mixture at a temperature at which the synthetic resin melts; and
discharging the water contained in the melted and kneaded product to outside by opening the closed container.

2. The method for producing a resin composite material according to claim 1, wherein the second mixture is compressed into a compressed product and then is fed into the closed container.

3. The method for producing a resin composite material according to claim 1, wherein the hydrous filler exhibits a property of a gel or suspension due to the water supplemented or a liquid medium excluding water.

4. The method for producing a resin composite material according to claim 1, wherein the step of discharging the water to outside is performed by setting opening of the closed container to a vapor pressure higher than atmospheric pressure and then setting the opening of the closed container to a vapor pressure lower than the atmospheric pressure in such a manner that the water is discharged at water content at a heat flow temperature of 1% or less.

5. The method for producing a resin composite material according to claim 1, wherein the hydrous filler includes at least one of:
a steam extraction residue;
a distillation residue;
a brewing residue;
a juice residue;
a food-factory residue;
a food residue;
paper manufacturing wastewater or waste pulp;
organic sludge in a chemical factory;
organic sludge in livestock farming;
sewage sludge;
bentonite sludge in outdoor construction industry;
gravel cleaning sludge;
aluminum hydroxide sludge;
metal surface treatment sludge;
polishing sludge;
filter aid waste;
wastewater treatment sludge in a cement factory; and
water purification sludge.

6. The method for producing a resin composite material according to claim 1, wherein the water-absorbing filler contains at least one of:
dry inorganic powder;
cellulosic biomass; and
an organic or inorganic compound in a fibrous form, a flocculent form, a powder form, or a porous form.

7. The method for producing a resin composite material according to any one of claim 1, wherein the hydrous filler is a concentrate that is concentrated by using a liquid medium excluding water.

8. A resin composite material containing a filler that is dispersed in a continuous phase of synthetic resin by a water-absorbing substance having hydrogen bonds with water,
wherein water content of the resin composite material at a heat flow temperature is 1% or less.

9. The resin composite material according to claim 8 containing at least one of: glycol; polyethylene glycol with a molecular weight of 400 or less; glycerin; and fatty acid.

10. The resin composite material according to claim 8, wherein the water-absorbing substance is a clay mineral-based substance, a thickener, a gelling agent, metal hydroxide, metal oxide, chloride, or sulfide.

11. The resin composite material according to claim 8, wherein the filler is a cellulosic material.

12. A sheet or film-shaped molded product of a melt of the resin composite material according to claim 8 having water content at a heat flow temperature of 0.3% or less and molded into a sheet or film of 0.2 mm or less by a T-die method or an inflation method.
